(19) United States
(12) Patent Application Publication
(10) Pub. No.: US 2024/0386032 A1
(43) Pub. Date: Nov. 21, 2024

(54) New Data Class Generation Based on Static Reference Data

(71) Applicant: International Business Machines Corporation, Armonk, NY (US)

(72) Inventors: Chun Hua Sun, Beijing (CN); Xu Bin Cai, Beijing (CN); Chun Leng, Beijing (CN); Wei Wang, Beijing (CN); Yi Yang Ren, Beijing (CN); Jian Ling Shi, Baoji (CN); Pin Lv, Beijing (CN); Xin Yu Wang, Beijing (CN); Yi Wang, Beijing (CN); Tao Zhuang, Beijing (CN)

(21) Appl. No.: 18/317,475

(22) Filed: May 15, 2023

(51) Int. Cl. G06F 16/28; G06F 16/22

(52) U.S. Cl. CPC G06F 16/285; G06F 16/221; G06F 2216/03

(57) ABSTRACT

New data class generation is provided. A dimension score is generated for each respective dimension of a plurality of predefined dimensions as relating to column attributes of a data asset while performing a static reference data analysis of the data asset. The dimension score of each respective dimension is added together to obtain a total dimension score for the data asset. It is determined whether the total dimension score of the data asset is greater than a predefined minimum dimension score threshold level. The data asset is identified as new static reference data in response to determining that the total dimension score of the data asset is greater than the predefined minimum dimension score threshold level. A new data class is generated based on the new static reference data.

### BACKGROUND

The disclosure relates generally to data governance and more specifically to generating new data classes for data governance.

Data governance manages data during its life cycle, from data acquisition to use and then to disposal. Data governance enables, for example, availability, quality, usability, and security of the data, which corresponds to an entity, such as, for example, an enterprise, company, business, organization, institution, agency, or the like, using different policies and standards. The policies and standards determine how data is gathered, stored, processed, and disposed of. For example, the policies and standards determine who can access what kinds of data and what kinds of data are under governance. Data governance also involves complying with external standards set by industry associations, government agencies, and other stakeholders.

### SUMMARY

According to one illustrative embodiment, a computer-implemented method for new data class generation is provided. A computer generates a dimension score for each respective dimension of a plurality of predefined dimensions as relating to column attributes of a data asset while performing a static reference data analysis of the data asset. The computer adds together the dimension score of each respective dimension to obtain a total dimension score for the data asset. The computer determines whether the total dimension score of the data asset is greater than a predefined minimum dimension score threshold level. The computer identifies the data asset as new static reference data in response to the computer determining that the total dimension score of the data asset is greater than the predefined minimum dimension score threshold level. The computer generates a new data class based on the new static reference data. According to other illustrative embodiments, a computer system and computer program product for new data class generation are provided.

### BRIEF DESCRIPTION OF THE DRAWINGS

FIG. 1 is a pictorial representation of a computing environment in which illustrative embodiments may be implemented;

FIG. 2 is a diagram illustrating an example of a new data class generation process in accordance with an illustrative embodiment;

FIG. 3 is a diagram illustrating an example of dimensions for identifying new static reference data in accordance with an illustrative embodiment;

FIG. 4 is a diagram illustrating an example of a dimension 1 table in accordance with an illustrative embodiment;

FIG. 5 is a diagram illustrating an example of a dimension 2 table in accordance with an illustrative embodiment;

FIG. 6 is a diagram illustrating an example of a dimension 3 table in accordance with an illustrative embodiment;

FIG. 7 is a diagram illustrating an example of a dimension 4 table in accordance with an illustrative embodiment;

FIG. 8 is a diagram illustrating an example of a dimension 5 table in accordance with an illustrative embodiment;

FIG. 9 is a diagram illustrating an example of a new static reference data identification process in accordance with an illustrative embodiment; and

FIGS. 10A-10C are a flowchart illustrating a process for new data class generation in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

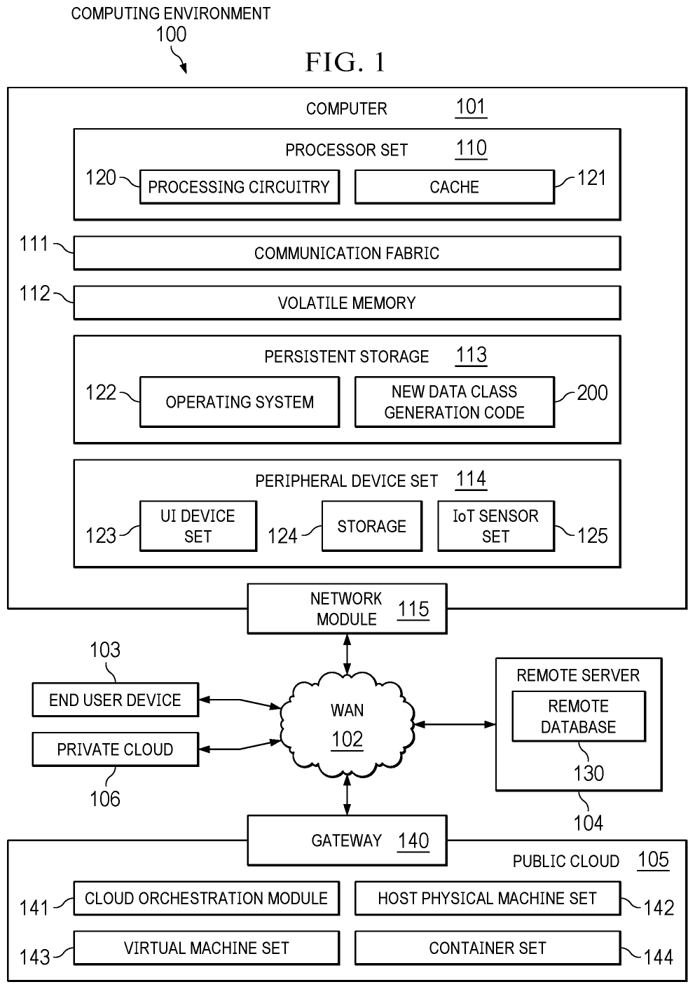

With reference now to the figures, and in particular, with reference to FIG. 1, a diagram of a data processing environment is provided in which illustrative embodiments may be implemented. It should be appreciated that FIG. 1 is only meant as an example and is not intended to assert or imply any limitation with regard to the environments in which different embodiments may be implemented. Many modifications to the depicted environment may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as new data class generation code 200. New data class generation code 200 dynamically generates new data classes based on identified new static reference data, which accelerates data classification processing for data governance. Data classification is the process of assigning a data class to a column of a table or data field. A data class describes the type of data contained in a column or data field, such as, for example, name, address, city, account number, credit card number, or the like. In other words, a data class describes the content of a particular column or data field. A column or data field is a location for a predetermined type of data. Any information that can describe an item, object, event, or the like can represent a column or data field.

New data class generation code 200 utilizes static reference data to classify column data or field data or generate new data classes. Typically, static reference data do not change over time. Static reference data can include, for example, units of measurement, country codes, state codes, city codes, business codes, and the like. New data class generation code 200 identifies new static reference data by utilizing a plurality of dimensions or characteristics corresponding to reference data. After identifying the new static reference data, new data class generation code 200 utilizes the newly identified static reference data to generate a new data class. Thus, new data class generation code 200 improves data classification efficiency in data governance, especially when analyzing a large number of data assets and certain data classes do not currently exist in the system.

In addition to new data class generation code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and new data class generation code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in new data class generation code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The new data class generation code included in block 200 includes at least some of the computer code involved in performing the inventive methods of illustrative embodiments.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (for example, a user of the new data class generation service provided by computer 101), and may take any of the forms discussed above in connection with computer 101. EUD 103 typically receives helpful and useful data from the operations of computer 101. For example, in a hypothetical case where computer 101 is designed to provide a new data class recommendation to the end user, this recommendation would typically be communicated from network module 115 of computer 101 through WAN 102 to EUD 103. In this way, EUD 103 can display, or otherwise present, the new data class recommendation to the end user. In some embodiments, EUD 103 may be a client device, such as thin client, heavy client, mainframe computer, desktop computer, laptop computer, tablet computer, smart watch, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a new data class recommendation based on historical data class information, then this historical data class information may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In data governance, data classification plays an important role, especially for column analysis in database management systems. Current data governance solutions provide data classes, which identify data classification for data assets. Typically, current data governance solutions include a plurality of defined data classes. These current data governance solutions analyze data or metadata of data assets and then use a specialized classifier to detect the probable data class for those data assets.

However, sometimes these current data governance solutions cannot classify some data assets (i.e., cannot find any matching data classes) as the data classes defined in the system are not enough. These current data governance solutions apply all the data classes in the system during the data classification analysis job. In other words, the data classification process of these current data governance solutions cannot return a result for a data asset when no matching data class exists in the system. As a result, a user has to manually define reference data to create a new data class and then use the new data class to identify the data asset.

Most matching methods include data class to data asset matching criteria. For example, one matching method utilizes a dictionary of valid values to determine whether a value of a column belongs to a data class. Another matching method utilizes valid values from a reference data set to determine whether a value of a column belongs to a data class. Yet another matching method utilizes a regular expression to determine whether a value of a column belongs to a data class. Still yet another matching method utilizes logic specified in a Java class of a defined set of Java classes to determine whether a value of a column or the column as a whole belongs to a data class. Illustrative embodiments utilize a minimum matching threshold level to determine whether illustrative embodiments assign a particular data class to a column.

Upon receiving an input from a user to perform a data classification analysis on a data asset, illustrative embodiments retrieve a plurality of existing data classes and a plurality of existing static reference data. Illustrative embodiments also retrieve a plurality of predefined dimensions associated with static reference data. For example: dimension 1 is a columns count dimension that represents the total number of columns in the data asset; dimension 2 is a distinct columns count dimension that represents the number of columns having distinct values in the data asset; dimension 3 is a columns named key dimension that represents the number of columns named key, identifier, code, or the like in the data asset; dimension 4 is a key columns value length dimension that represents the percentage of values having the same length in the columns named key in the data asset; dimension 5 is a key columns value format dimension that represents the percentage of values having the same format in the columns named key in the data asset; and the like. In addition, illustrative embodiments retrieve the data asset from data asset storage to perform the data classification analysis on the data asset.

Illustrative embodiments generate a temporary static reference data record corresponding to the data asset. The temporary static reference data record includes fields that store information, such as, for example, name of the data asset, names of columns of the data asset, number of columns in the data asset, dimension scores for the data asset, and the like. Illustrative embodiments utilize information in the temporary static reference data record to determine whether the data asset is new static reference data.

Illustrative embodiments select a column from a set of columns of the data asset. Illustrative embodiments then perform the data classification analysis on the selected column using the plurality of existing data classes. In other words, illustrative embodiments apply each of the existing data classes to the selected column one at a time. In response to illustrative embodiments determining that a match exists between the selected column and a data class of the plurality of existing data classes based on the data classification analysis, illustrative embodiments return the data class matching the selected column to the user. In response to illustrative embodiments determining that a match does not exist between the selected column and a data class of the plurality of existing data classes based on the data classification analysis, illustrative embodiments identify values in a set of rows of the selected column.

Illustrative embodiments determine whether the values in the set of rows of the selected column match a value of one of the plurality of existing static reference data. In response to illustrative embodiments determining that the values in the set of rows of the selected column match a value of one of the plurality of existing static reference data, illustrative embodiments utilize a linked data class to the existing static reference data that match the values in the set of rows of the selected column to classify the selected column and return the linked data class to the user. In response to illustrative embodiments determining that the values in the set of rows of the selected column do not match a value of one of the plurality of existing static reference data, illustrative embodiments perform a static reference data analysis of the data asset by generating a score for each respective dimension of the plurality of predefined dimensions as relating to attributes of the set of columns in the data asset.

It should be noted that for each predefined dimension, the user sets a score for each respective row of a dimension table corresponding to that particular dimension (e.g., a columns count dimension, a distinct columns count dimension, a columns named key dimension, a key columns value length dimension, a key columns value format dimension, or the like). While performing the static reference data analysis on the data asset, if column attributes of the data asset match a given row of the dimension table, then illustrative embodiments assign the score corresponding to that row to the data asset. In addition, illustrative embodiments can multiply the assigned score by a weight, which is set by the user for that particular dimension row, to obtain a total score for that particular dimension. It should be noted that the user also sets a weight for each respective dimension row to show the importance of each row corresponding to that dimension. For example, if the user believes that one row of a particular dimension is more important than other dimension rows, then the user sets a higher weight value to that particular dimension row.

Afterward, illustrative embodiments add all of the total scores of the different dimensions together to obtain a final total dimension score for the data asset. In other words, for one data asset (e.g., a table comprised of a set of columns), illustrative embodiments determine the final total dimension score for the data asset by summing the total scores of all the dimensions corresponding to the data asset. Illustrative embodiments then determine whether the final total dimension score of the data asset is greater than a predefined minimum dimension score threshold level.

In response to illustrative embodiments determining that the final total dimension score of the data asset is greater than the predefined minimum dimension score threshold level, illustrative embodiments identify the data asset as new static reference data and add the new static reference data to the plurality of existing static reference data. Further, in response to illustrative embodiments identifying the data asset as new static reference data, illustrative embodiments generate a new data class based on the new static reference data and add the new data class to the plurality of existing data classes. Furthermore, illustrative embodiments link the new reference data to the new data class. Moreover, illustrative embodiments mark the temporary static reference data record corresponding to the data asset as a persistent static reference data record and store the persistent static reference data record in a static reference data repository.

In response to illustrative embodiments determining that the final total dimension score of the data asset is less than or equal to the predefined minimum dimension score threshold level, illustrative embodiments return the column and data asset to the user for manual data classification. It should be noted that illustrative embodiments perform the above process for each column of the data asset.

Thus, illustrative embodiments are capable of dynamically generating new data classes based identified new static reference data, which accelerates data classification processing. In other words, illustrative embodiments generate new data classes that do not currently exist in the system based on newly identified static reference data. As a result, illustrative embodiments provide a self-improved data governance system by automatically enriching the system with newly generated data classes.

Thus, illustrative embodiments provide one or more technical solutions that overcome a technical problem with an inability of a system to return a data classification result for a data asset when no matching data class exists in the system. As a result, these one or more technical solutions provide a technical effect and practical application in the field of data governance.

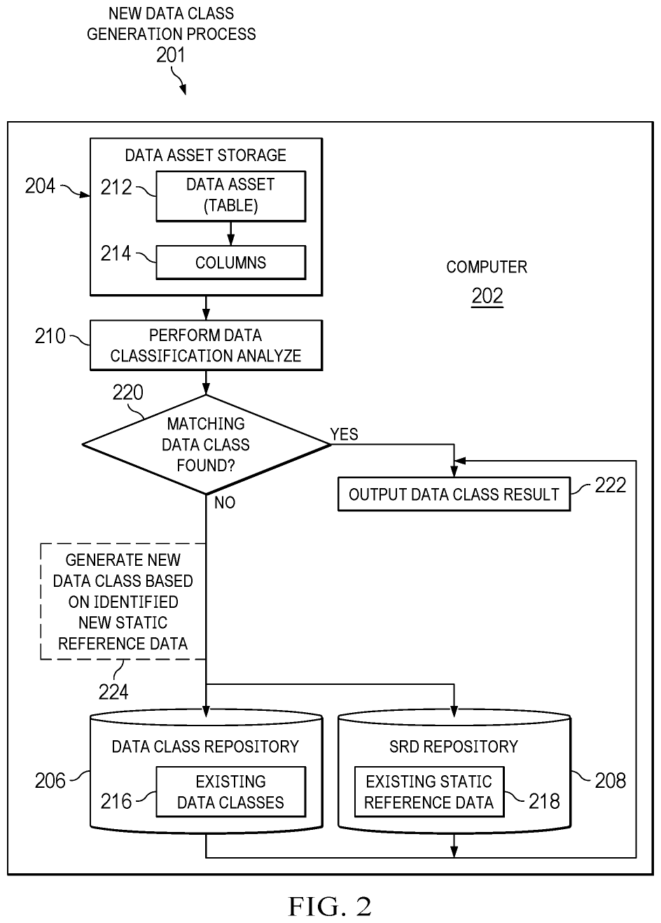

With reference now to FIG. 2, a diagram illustrating an example of a new data class generation process is depicted in accordance with an illustrative embodiment. New data class generation process 201 is implemented in computer 202. Computer 202 may be, for example, computer 101 in FIG. 1.

In this example, computer 202 includes data asset storage 204, data class repository 206, and static reference data (SRD) repository 208. Data asset storage 204 contains a plurality of data assets. Data class repository 206 contains a plurality of defined and existing data classes. SRD repository 208 contains a plurality of defined and existing static reference data.

At 210, computer 202 performs a data classification analysis on data asset 212, which is a table comprised of columns 214. However, it should be noted that data asset 212 can represent any type of data asset, such as, for example, a table, database, database column, flat file, rectangular file, data fields, data records, or the like. While performing the data classification analysis on data asset 212, computer 202 tries to classify columns 214 using existing data classes 216 or existing static reference data 218. At 220, computer 202 makes a determination as to whether a matching data class was found. If a matching data class was found, then, at 222, computer 202 outputs the data class result. If a matching data class was not found, then, at 224, computer 202 generates a new data class based on identified new static reference data. Computer 202 adds the new data class to existing data classes 216 and the identified new static reference data to existing static reference data 218.

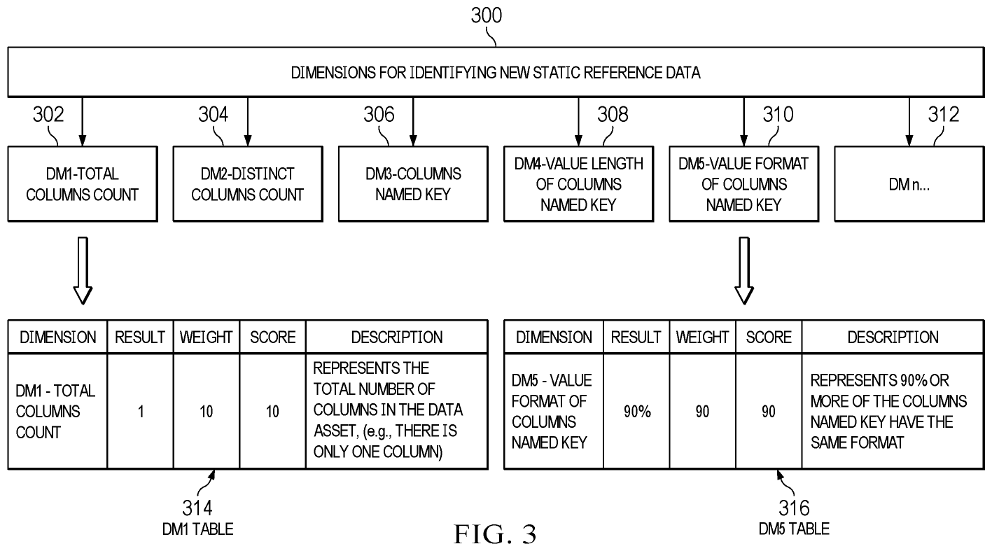

With reference now to FIG. 3, a diagram illustrating an example of dimensions for identifying new static reference data is depicted in accordance with an illustrative embodiment. Dimensions for identifying new static reference data 300 can be implemented in a computer, such as, for example, computer 202 in FIG. 2. Dimensions for identifying new static reference data 300 represent a plurality of predefined dimensions associated with static reference data.

In this example, dimensions for identifying new static reference data 300 include dimension 1 (DM1) 302, dimension 2 (DM2) 304, dimension 3 (DM3) 306, dimension 4 (DM4) 308, dimension 5 (DM5) 310, and other dimensions 312. DM1 302 is a total columns count dimension. DM2 304 is a distinct columns count dimension. DM3 306 is a columns named key dimension. DM4 308 is a value length of columns named key dimension. DM5 310 is a value format of columns named key dimension. Other dimensions 312 can represent any other type of dimension for identifying new static reference data. In other words, dimensions for identifying new static reference data 300 are intended as examples only and not as limitations on illustrative embodiments. Thus, dimensions for identifying new static reference data 300 can include any type and number of dimensions for identifying new static reference data.

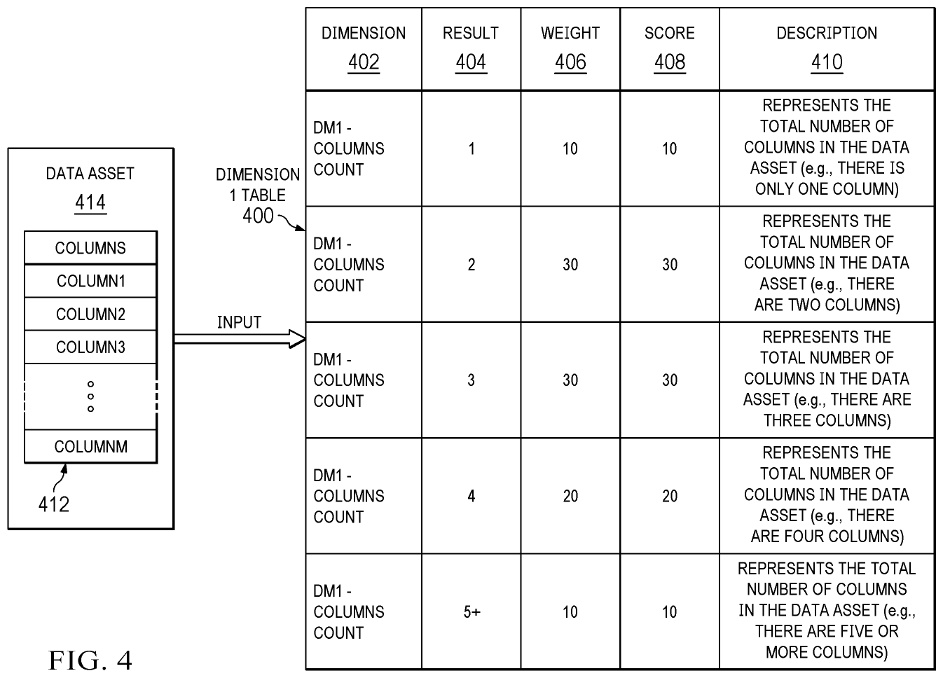

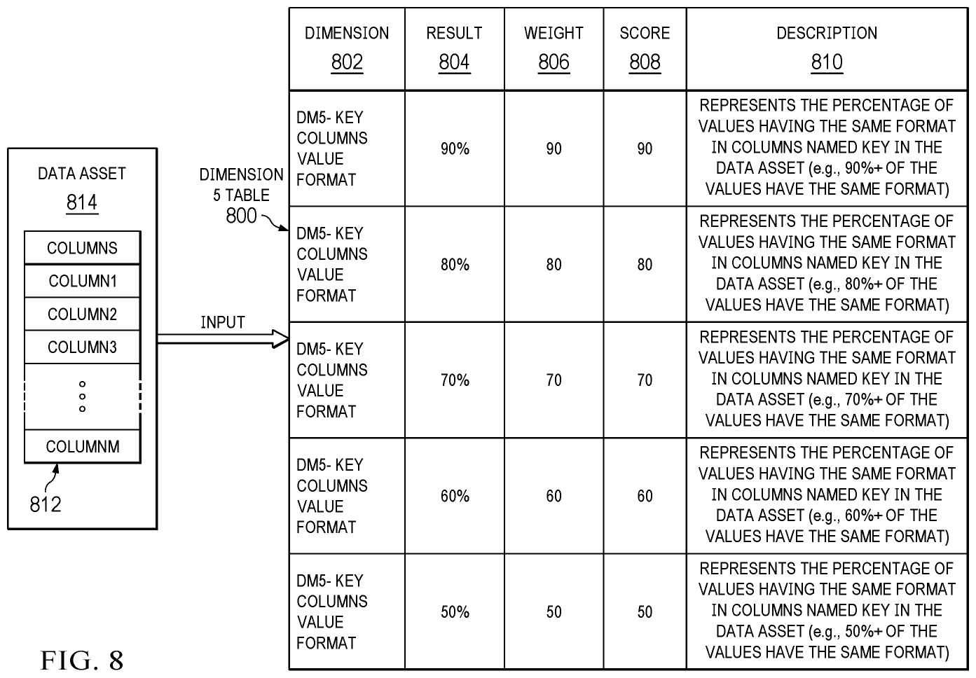

Also in this example, DM1 302 corresponds to DM1 table 314. DM1 table 314 can be, for example, dimension 1 table 400 in FIG. 4. In addition, DM5 310 corresponds to DM5 table 316. DM5 table 316 can be, for example, dimension 5 table 800 in FIG. 8. However, it should be noted that DM2 304, DM3 306, DM4 308, and other dimensions 312 have corresponding dimension tables as well even though not shown in this example.

With reference now to FIG. 4, a diagram illustrating an example of a dimension 1 table is depicted in accordance with an illustrative embodiment. Dimension 1 table 400 can be implemented in a computer, such as, for example, computer 202 in FIG. 2.

In this example, dimension 1 table 400 includes dimension 402, result 404, weight 406, score 408, and description 410. Dimension 402 identifies the type of dimension (i.e., a columns count dimension) that is associated with dimension 1 table 400. Result 404 identifies how many columns (i.e., 1, 2, 3, 4, or 5+) are in a data asset. In other words, result 404 identifies an attribute of the data asset. A user sets weight 406 and score 408 based on the user-assigned importance of each respective result 404. Description 410 provides an explanation of dimension 402. In this example, dimension 402 corresponds to the total number of columns in the data asset (e.g., the total number of columns 412 in data asset 414). Columns 412 and data asset 414 may be, for example, columns 214 in data asset 212 in FIG. 2.

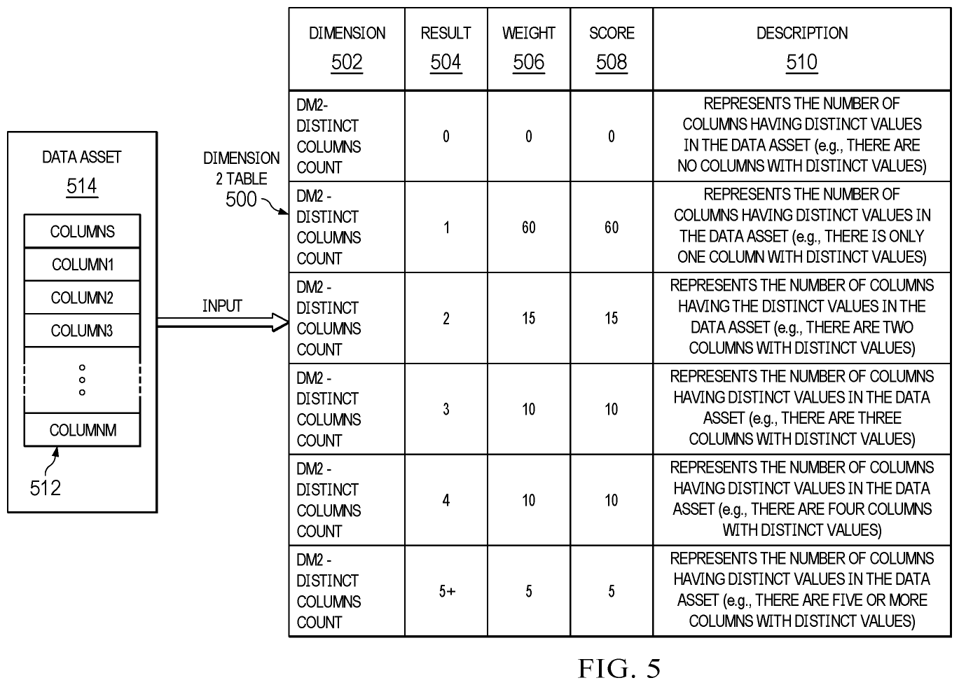

With reference now to FIG. 5, a diagram illustrating an example of a dimension 2 table is depicted in accordance with an illustrative embodiment. Dimension 2 table 500 can be implemented in a computer, such as, for example, computer 202 in FIG. 2.

In this example, dimension 2 table 500 includes dimension 502, result 504, weight 506, score 508, and description 510. Dimension 502 identifies the type of dimension (i.e., a distinct columns count dimension) that is associated with dimension 2 table 500. Result 504 identifies how many columns (i.e., 0, 1, 2, 3, 4, or 5+) of a data asset include distinct values. In other words, result 504 identifies another attribute of the data asset. A user sets weight 506 and score 508 based on the user-assigned importance of each respective result 504. Description 510 provides an explanation of dimension 502. In this example, dimension 502 corresponds to the number of columns having distinct values in the data asset (e.g., the number of columns in columns 512 that have a distinct value in data asset 514).

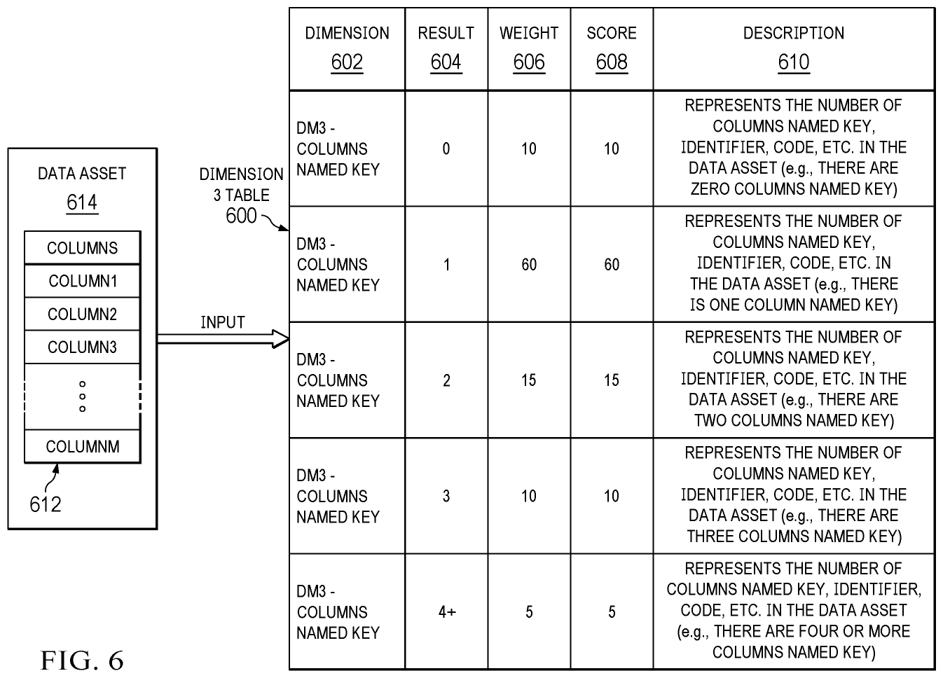

With reference now to FIG. 6, a diagram illustrating an example of a dimension 3 table is depicted in accordance with an illustrative embodiment. Dimension 3 table 600 can be implemented in a computer, such as, for example, computer 202 in FIG. 2.

In this example, dimension 3 table 600 includes dimension 602, result 604, weight 606, score 608, and description 610. Dimension 602 identifies the type of dimension (i.e., a columns named key dimension) that is associated with dimension 3 table 600. Result 604 identifies how many columns (i.e., 0, 1, 2, 3, or 4+) of a data asset are named key. In other words, result 604 identifies yet another attribute of the data asset. A user sets weight 606 and score 608 based on the user-assigned importance of each respective result 604. Description 610 provides an explanation of dimension 602. In this example, dimension 602 corresponds to the number of columns named key, identifier, code, or the like, in the data asset (e.g., the number of columns in columns 512 that have the name key, identifier, code, or the like in data asset 514).

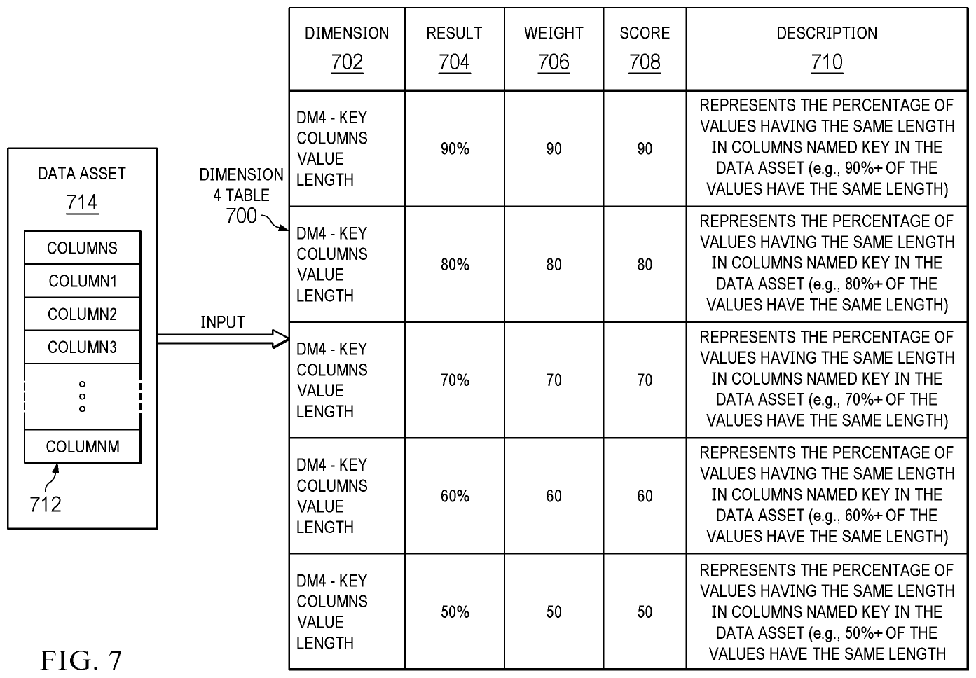

With reference now to FIG. 7, a diagram illustrating an example of a dimension 4 table is depicted in accordance with an illustrative embodiment. Dimension 4 table 700 can be implemented in a computer, such as, for example, computer 202 in FIG. 2.

In this example, dimension 4 table 700 includes dimension 702, result 704, weight 706, score 708, and description 710. Dimension 702 identifies the type of dimension (i.e., a key columns value length dimension) that is associated with dimension 4 table 700. Result 704 identifies a percentage (i.e., 90%, 80%, 70%, 60%, or 50%) of columns in a data asset having the same value length. In other words, result 704 identifies yet another attribute of the data asset. A user sets weight 706 and score 708 based on the user-assigned importance of each respective result 704. Description 710 provides an explanation of dimension 702. In this example, dimension 702 corresponds to the percentage of values having the same length in columns named key in the data asset (e.g., the percentage of values having the same length in the columns named key in columns 712 in data asset 714).

With reference now to FIG. 8, a diagram illustrating an example of a dimension 5 table is depicted in accordance with an illustrative embodiment. Dimension 5 table 800 can be implemented in a computer, such as, for example, computer 202 in FIG. 2.

In this example, dimension 5 table 800 includes dimension 802, result 804, weight 806, score 808, and description 810. Dimension 802 identifies the type of dimension (i.e., a key columns value format dimension) that is associated with dimension 5 table 800. Result 804 identifies a percentage (i.e., 90%, 80%, 70%, 60%, or 50%) of columns in a data asset having the same value format. In other words, result 804 identifies yet another attribute of the data asset. A user sets weight 806 and score 808 based on the user-assigned importance of each respective result 804. Description 810 provides an explanation of dimension 802. In this example, dimension 802 corresponds to the percentage of values having the same format in columns named key in the data asset (e.g., the percentage of values having the same format in the columns named key in columns 812 in data asset 814).

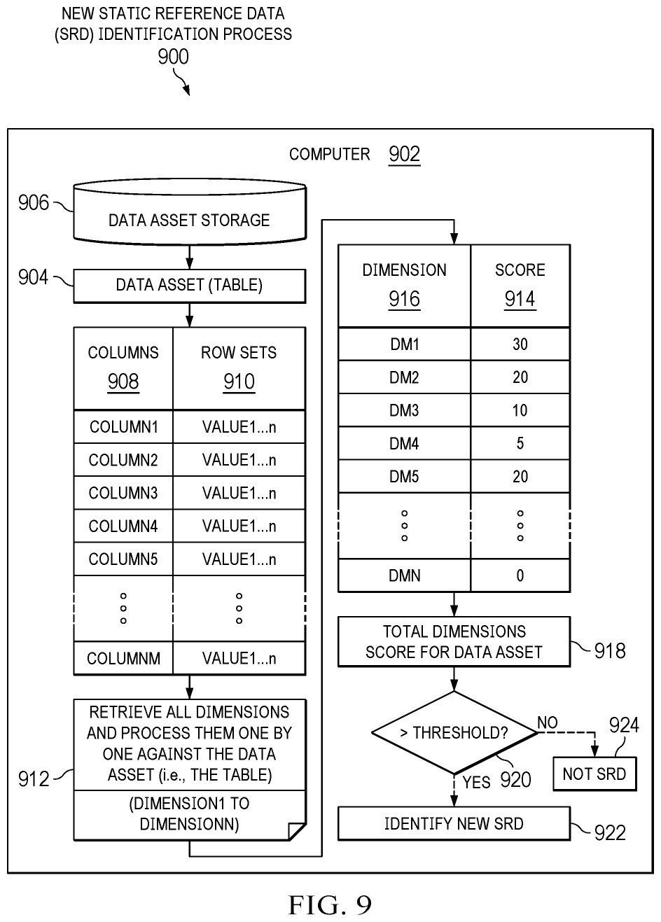

With reference now to FIG. 9, a diagram illustrating an example of a new static reference data identification process is depicted in accordance with an illustrative embodiment. New static reference data identification process 900 is implemented in computer 902. Computer 902 can be, for example, computer 202 in FIG. 2.

In this example, computer 902 is performing a data classification analysis on data asset 904 retrieved from data asset storage 906. In this example, data asset 904 is a table comprised of columns 908 and row sets 910. However, in this example, computer 902 is not able to classify a particular column of data asset 904 using existing data classes or existing static reference data, such as, for example, existing data classes 216 and existing static reference data 218 in FIG. 2. As a result, at 912, computer 902 retrieves all dimensions (e.g., dimension 1 to dimension n) and processes each of the dimensions one by one against column attributes of data asset 904.

While processing the dimensions one by one against column attributes of data asset 904, computer 902 generates score 914 for each respective dimension 916. At 918, computer 902 generates a total dimension score for data asset 904 by summing together each score 914. At 920, computer 902 determines whether the total dimension score for data asset 904 is greater than a defined minimum dimension score threshold level.

Computer 902 determines the predefined minimum dimension score threshold level by, for example, first sorting the dimension table corresponding to each respective dimension, such as dimension 1 table 400 in FIG. 4, dimension 2 table 500 in FIG. 5, dimension 3 table 600 in FIG. 6, dimension 4 table 700 in FIG. 7, and dimension 5 table 800 in FIG. 8, by total score values (i.e., weight*score) of each respective row from a highest total score value at the top row of the table to a lowest total score value at the bottom row of the table. After sorting each respective dimension table from the highest total score value at the top to the lowest total score value at the bottom row of the table, computer 902 selects the total score value of the third row of each sorted dimension table, which represents the individual dimension score threshold value of each dimension. Then, computer 902 sums together the individual dimension score threshold value of each dimension (i.e., the total score values from the third row of each sorted dimension table) to generate the predefined minimum dimension score threshold level. As an illustrative example, the predefined minimum dimension score threshold level would be equal to (20*20)+(10*10)+(10*10)+(70*70)+(70*70) or 10,400 based on computer 902 sorting dimension 1 table 400 in FIG. 4, dimension 2 table 500 in FIG. 5, dimension 3 table 600 in FIG. 6, dimension 4 table 700 in FIG. 7, and dimension 5 table 800 in FIG. 8, by total score values (i.e., weight*score) of each respective row from the highest total score value at the top to the lowest total score value at the bottom of the table and then selecting the third row values.

If computer 902 determines that the total dimension score is greater than the defined minimum dimension score threshold level, then, at 922, computer 902 identifies data asset 904 as new static reference data. Conversely, if computer 902 determines that the total dimension score is less than the defined minimum dimension score threshold level, then, at 924, computer 902 does not identify data asset 904 as new static reference data.

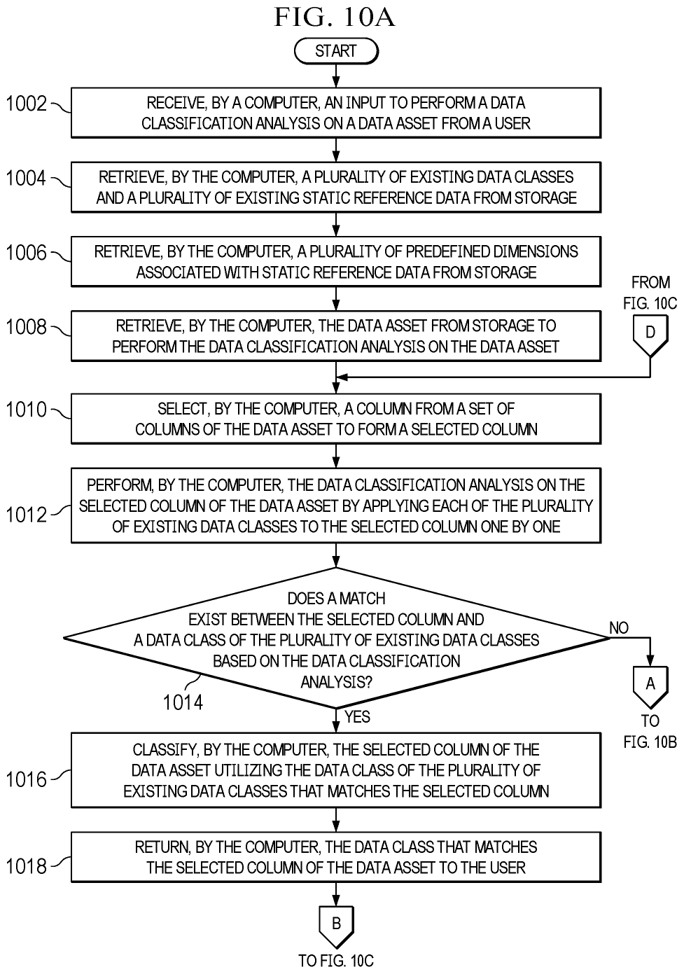

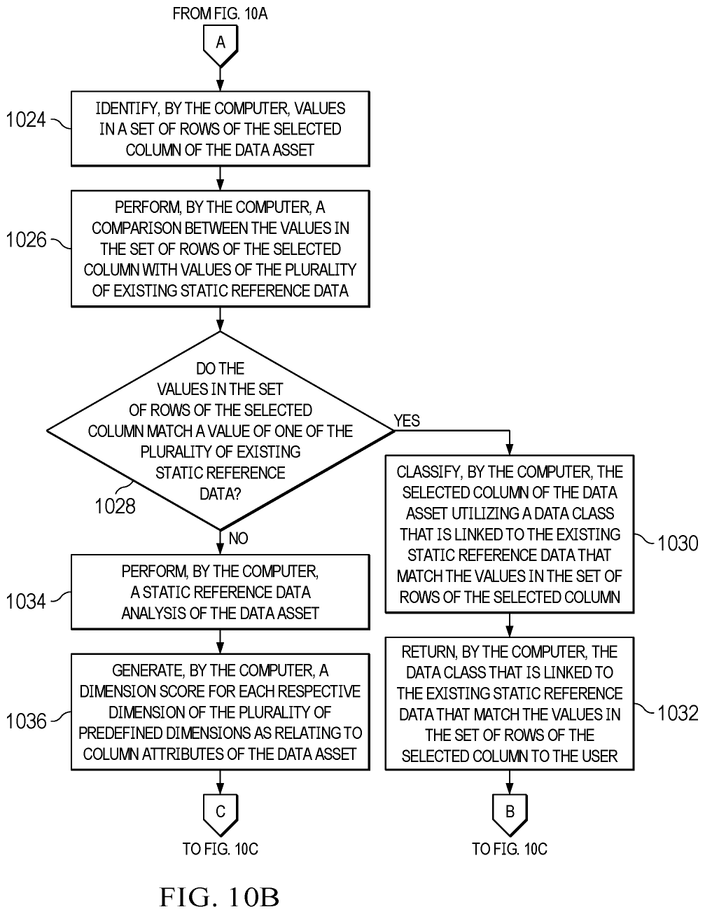

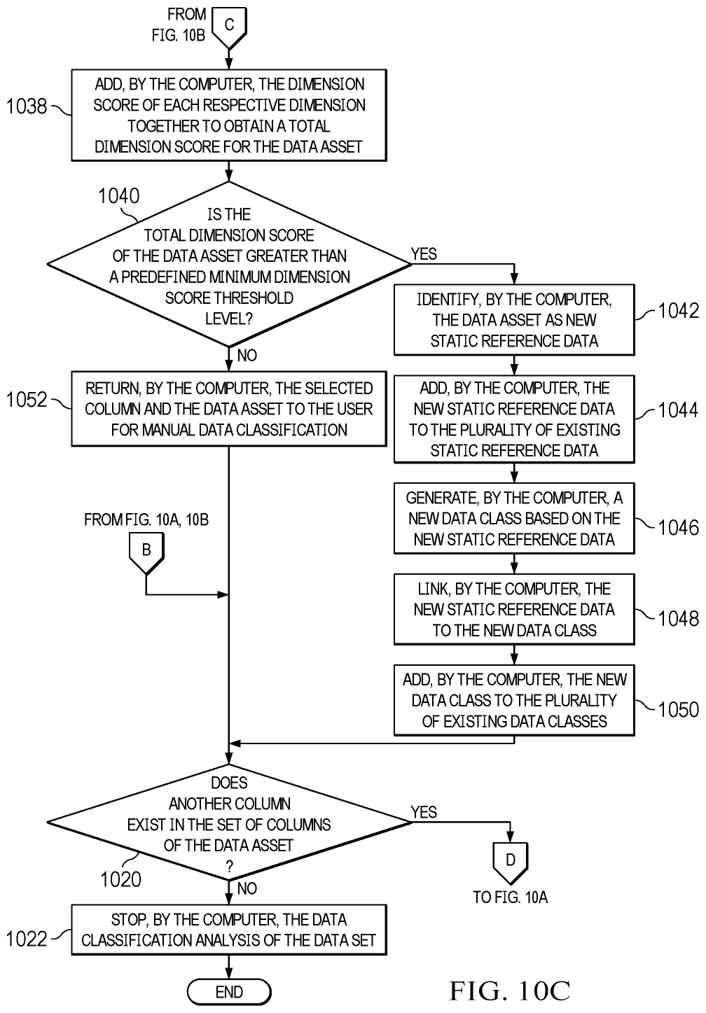

With reference now to FIGS. 10A-10C, a flowchart illustrating a process for new data class generation is shown in accordance with an illustrative embodiment. The process shown in FIGS. 10A-10C may be implemented in a computer, such as, for example, computer 101 in FIG. 1 or computer 202 in FIG. 2. For example, the process shown in FIGS. 10A-10C may be implemented in new data class generation code 200 in FIG. 1.

The process begins when the computer receives an input to perform a data classification analysis on a data asset from a user (step 1002). In response to receiving the input to perform the data classification analysis on the data asset, the computer retrieves a plurality of existing data classes and a plurality of existing static reference data from storage (step 1004). Also, the computer retrieves a plurality of predefined dimensions associated with static reference data from storage (step 1006). In addition, the computer retrieves the data asset from storage to perform the data classification analysis on the data asset (step 1008).

In response to retrieving the data asset from storage, the computer selects a column from a set of columns of the data asset to form a selected column (step 1010). The computer performs the data classification analysis on the selected column of the data asset by applying each of the plurality of existing data classes to the selected column one by one (step 1012). The computer makes a determination as to whether a match exists between the selected column and a data class of the plurality of existing data classes based on the data classification analysis (step 1014).

If the computer determines that a match does exist between the selected column and a data class of the plurality of existing data classes based on the data classification analysis, yes output of step 1014, then the computer classifies the selected column of the data asset utilizing the data class of the plurality of existing data classes that matches the selected column (step 1016). Further, the computer returns the data class that matches the selected column of the data asset to the user (step 1018).

Afterward, the computer makes a determination as to whether another column exists in the set of columns of the data asset (step 1020). If the computer determines that another column does exist in the set of columns of the data asset, yes output of step 1020, then the process returns to step 1010 where the computer selects another column from the set of columns of the data asset. If the computer determines that another column does not exist in the set of columns of the data asset, no output of step 1020, then the computer stops the data classification analysis of the data asset (step 1022). Thereafter, the process terminates.

Returning again to step 1014, if the computer determines that a match does not exist between the selected column and a data class of the plurality of existing data classes based on the data classification analysis, no output of step 1014, then the computer identifies values in a set of rows of the selected column of the data asset (step 1024). The computer performs a comparison between the values in the set of rows of the selected column with values of the plurality of existing static reference data (step 1026). The computer makes a determination as to whether the values in the set of rows of the selected column match a value of one of the plurality of existing static reference data based on the comparison (step 1028).

If the computer determines that the values in the set of rows of the selected column do match a value of one of the plurality of existing static reference data based on the comparison, yes output of step 1028, then the computer classifies the selected column of the data asset utilizing a data class that is linked to the existing static reference data that match the values in the set of rows of the selected column (step 1030). In addition, the computer returns the data class that is linked to the existing static reference data that match the values in the set of rows of the selected column to the user (step 1032). Thereafter, the process returns to step 1010 where the computer selects another column from the set of columns of the data asset.

Returning again to step 1028, if the computer determines that the values in the set of rows of the selected column do not match a value of one of the plurality of existing static reference data based on the comparison, no output of step 1028, then the computer performs a static reference data analysis of the data asset (step 1034). While performing the static reference data analysis of the data asset, the computer generates a dimension score for each respective dimension of the plurality of predefined dimensions as relating to column attributes of the data asset (step 1036). Afterward, the computer adds together the dimension score of each respective dimension to obtain a total dimension score for the data asset (step 1038). The computer makes a determination as to whether the total dimension score of the data asset is greater than a predefined minimum dimension score threshold level (step 1040).

If the computer determines that the total dimension score of the data asset is greater than the predefined minimum dimension score threshold level, yes output of step 1040, then the computer identifies the data asset as new static reference data (step 1042). The computer adds the new static reference data to the plurality of existing static reference data (step 1044). Further, the computer generates a new data class based on the new static reference data (step 1046). Furthermore, the computer links the new static reference data to the new data class (step 1048). Moreover, the computer adds the new data class to the plurality of existing data classes (step 1050). Thereafter, the process returns to step 1010 where the computer selects another column from the set of columns of the data asset.

Returning again to step 1040, if the computer determines that the total dimension score of the data asset is not greater than the predefined minimum dimension score threshold level, no output of step 1040, then the computer returns the selected column and the data asset to the user for manual data classification (step 1052). Thereafter, the process returns to step 1010 where the computer selects another column from the set of columns of the data asset.

Thus, illustrative embodiments of the present disclosure provide a computer-implemented method, computer system, and computer program product for generating new data classes based on newly identified static reference data corresponding to a data asset. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for new data class generation, the computer-implemented method comprising:
generating, by a computer, a dimension score for each respective dimension of a plurality of predefined dimensions as relating to column attributes of a data asset while performing a static reference data analysis of the data asset;
adding, by the computer, the dimension score of each respective dimension together to obtain a total dimension score for the data asset;
determining, by the computer, whether the total dimension score of the data asset is greater than a predefined minimum dimension score threshold level;
identifying, by the computer, the data asset as new static reference data in response to the computer determining that the total dimension score of the data asset is greater than the predefined minimum dimension score threshold level; and
generating, by the computer, a new data class based on the new static reference data.

2. The computer-implemented method of claim 1, further comprising:
receiving, by the computer, an input to perform a data classification analysis on the data asset;
retrieving, by the computer, a plurality of existing data classes and a plurality of existing static reference data;
retrieving, by the computer, the plurality of predefined dimensions; and
retrieving, by the computer, the data asset to perform the data classification analysis on the data asset.

3. The computer-implemented method of claim 2, further comprising:
selecting, by the computer, a column from a set of columns of the data asset;
applying, by the computer, each of the plurality of existing data classes to the column one by one; and
determining, by the computer, whether a match exists between the column and a data class of the plurality of existing data classes.

4. The computer-implemented method of claim 3, further comprising:
classifying, by the computer, the column of the data asset utilizing the data class of the plurality of existing data classes that matches the column; and
returning, by the computer, the data class that matches the column of the data asset.

5. The computer-implemented method of claim 3, further comprising:
identifying, by the computer, values in a set of rows of the column of the data asset in response to the computer determining that a match does not exist between the column and a data class of the plurality of existing data classes;
performing, by the computer, a comparison between the values in the set of rows of the column with values of the plurality of existing static reference data; and
determining, by the computer, whether the values in the set of rows of the column match a value of one of the plurality of existing static reference data based on the comparison.

6. The computer-implemented method of claim 5, further comprising:
classifying, by the computer, the column of the data asset utilizing a data class that is linked to existing static reference data that match the values in the set of rows of the column in response to the computer determining that the values in the set of rows of the column do match a value of one of the plurality of existing static reference data based on the comparison; and
returning, by the computer, the data class that is linked to the existing static reference data that match the values in the set of rows of the column.

7. The computer-implemented method of claim 5, further comprising:
performing, by the computer, the static reference data analysis of the data asset in response to the computer determining that the values in the set of rows of the column do not match a value of one of the plurality of existing static reference data based on the comparison.

8. The computer-implemented method of claim 1, further comprising:
returning, by the computer, the data asset for manual data classification in response to the computer determining that the total dimension score of the data asset is not greater than the predefined minimum dimension score threshold level.

9. The computer-implemented method of claim 1, further comprising:
linking, by the computer, the new static reference data to the new data class.

10. The computer-implemented method of claim 1, wherein the plurality of predefined dimensions includes a columns count dimension that represents a total number of columns in the data asset, a distinct columns count dimension that represents a number of columns having distinct values in the data asset, a columns named key dimension that represents a number of columns named key in the data asset, a key columns value length dimension that represents a percentage of values having a same length in the columns named key in the data asset, and a key columns value format dimension that represents a percentage of values having a same format in the columns named key in the data asset.

11. A computer system for new data class generation, the computer system comprising:
a communication fabric;
a storage device connected to the communication fabric, wherein the storage device stores program instructions; and
a processor connected to the communication fabric, wherein the processor executes the program instructions to:
generate a dimension score for each respective dimension of a plurality of predefined dimensions as relating to column attributes of a data asset while performing a static reference data analysis of the data asset;
add together the dimension score of each respective dimension to obtain a total dimension score for the data asset;
determine whether the total dimension score of the data asset is greater than a predefined minimum dimension score threshold level;
identify the data asset as new static reference data in response to determining that the total dimension score of the data asset is greater than the predefined minimum dimension score threshold level; and
generate a new data class based on the new static reference data.

12. The computer system of claim 11, wherein the processor further executes the program instructions to:
receive an input to perform a data classification analysis on the data asset;
retrieve a plurality of existing data classes and a plurality of existing static reference data;
retrieve the plurality of predefined dimensions; and
retrieve the data asset to perform the data classification analysis on the data asset.

13. The computer system of claim 12, wherein the processor further executes the program instructions to:
select a column from a set of columns of the data asset;
apply each of the plurality of existing data classes to the column one by one; and
determine whether a match exists between the column and a data class of the plurality of existing data classes.

14. A computer program product for new data class generation, the computer program product comprising a computer-readable storage medium having program instructions embodied therewith, the program instructions executable by a computer to cause the computer to:
generate a dimension score for each respective dimension of a plurality of predefined dimensions as relating to column attributes of a data asset while performing a static reference data analysis of the data asset;
add together the dimension score of each respective dimension to obtain a total dimension score for the data asset;
determine whether the total dimension score of the data asset is greater than a predefined minimum dimension score threshold level;
identify the data asset as new static reference data in response to determining that the total dimension score of the data asset is greater than the predefined minimum dimension score threshold level; and
generate a new data class based on the new static reference data.

15. The computer program product of claim 14, wherein the program instructions further cause the computer to:
receive an input to perform a data classification analysis on the data asset;
retrieve a plurality of existing data classes and a plurality of existing static reference data;
retrieve the plurality of predefined dimensions; and
retrieve the data asset to perform the data classification analysis on the data asset.

16. The computer program product of claim 15, wherein the program instructions further cause the computer to:
select a column from a set of columns of the data asset;
apply each of the plurality of existing data classes to the column one by one; and
determine whether a match exists between the column and a data class of the plurality of existing data classes.

17. The computer program product of claim 16, wherein the program instructions further cause the computer to:
classify the column of the data asset utilizing the data class of the plurality of existing data classes that matches the column; and
return the data class that matches the column of the data asset.

18. The computer program product of claim 16, wherein the program instructions further cause the computer to:
identify values in a set of rows of the column of the data asset in response to determining that a match does not exist between the column and a data class of the plurality of existing data classes;
perform a comparison between the values in the set of rows of the column with values of the plurality of existing static reference data; and
determine whether the values in the set of rows of the column match a value of one of the plurality of existing static reference data based on the comparison.

19. The computer program product of claim 18, wherein the program instructions further cause the computer to:
classify the column of the data asset utilizing a data class that is linked to existing static reference data that match the values in the set of rows of the column in response to determining that the values in the set of rows of the column do match a value of one of the plurality of existing static reference data based on the comparison; and
return the data class that is linked to the existing static reference data that match the values in the set of rows of the column.

20. The computer program product of claim 18, wherein the program instructions further cause the computer to:
perform the static reference data analysis of the data asset in response to determining that the values in the set of rows of the column do not match a value of one of the plurality of existing static reference data based on the comparison.
